(19) United States
(12) Patent Application Publication
(10) Pub. No.: US 2015/0202916 A1
(43) Pub. Date: Jul. 23, 2015

(54) METHOD FOR PRODUCING DUPLICATES OF AN OBJECT HAVING A THREE-DIMENSIONAL DECORATIVE SURFACE

(71) Applicant: Leonardo PANETTIERI, Pisa (IT)

(72) Inventor: Leonardo Panettieri, Pisa (IT)

(21) Appl. No.: 14/419,567

(22) PCT Filed: Aug. 8, 2013
(86) PCT No.: PCT/IB2013/056491

§ 371 Date: Feb. 4, 2015

(30) Foreign Application Priority Data
Aug. 9, 2012 (IT) PI2012A000093
Mar. 19, 2013 (IT) PI2013A000019

(51) Int. Cl. B44C 1/18; B44F 7/00

(52) U.S. Cl. CPC B44C 1/18; B44F 7/00

(57) ABSTRACT

A process for producing duplicates in series of an object having a decorative three-dimensional surface having a plurality of crests, or protrusions, each of which has a predetermined thickness, or height. The process including the steps of introducing the object in a container body having a side containing edge that protrudes, in use, beyond the object. A step is provided of distributing on the object a first hardening material suitable to cover the decorative three-dimensional surface of the object, and a step of hardening the hardening material obtaining a mould provided at the face oriented towards the object of a three-dimensional surface reproducing in negative the three-dimensional surface of the object.

### FIELD OF THE INVENTION

The present invention relates to the field of reproductions of works, such as paintings, in particular oil paintings, but also pictures, and, in particular, it relates to a process for producing duplicates in series of an original work.

### DESCRIPTION OF THE PRIOR ART

As well known, different methods exist for reproducing original works in series, in particular pictorial works, or photographic works.

A known process for reproducing pictures provides to photograph the work and to project the photograph so obtained on a cloth, or other support suitable for receiving the reproduction.

It is then provided the intervention of an operator who provides to achieve the reproduction of the work, following the lines of the projected painting, carrying out the necessary brush-strokes of colour.

However this process has many drawbacks.

Firstly, the final result of the process is obviously linked to the “touch” of the operator i.e. to its artistic inspiration and to its experience, because at the end it is the operator who makes the reproduction of the original pictorial work. Therefore, this type of process needs a long time for being completed and does not allow to reproduce in series the original pictorial work. In fact, even if the different reproductions made with the known technologies can be similar one to each other, they present clear differences, since the coats, or brush-strokes, of the operator are different from time to time.

Furthermore, though the original reproduction is faithful to the original pictorial work, it presents in any case, even to the unskilled eyes, some clear and macroscopic differences with respect to the original pictorial work. This because the above described process considers exclusively the spatial size (x,y) of the pictorial work whose aesthetic effect overall is, instead, strongly affected by the thickness of the brush-strokes that, in the process above described, as well as in other similar processes, is a parameter to which the right importance is not attached. The thickness of the colour affects, in particular, the way with which the light is reflected by the surface of the painting and that therefore produces a particular aesthetic effect.

In order to try to overcome this drawback different processes have been proposed. For example in JP7257099 a process is described that provides to distribute a thermosetting substance directly on the original pictorial work. A pressing and a heating step of the substance follows for causing it to a right hardening, at the end of that, the obtained mould reproduces in negative the surface of the pictorial work. Moreover, a distribution step of a resin layer in liquid state is provided on a base material. Then, a step follows in which the mould previously obtained is arranged on the resin layer and pressed against the same up to the hardening of the resin. On the hardened resin layer is, then, connected a plastic film having a determined pattern that once is adhered to the resin layer reproduces an original work.

In said process, as well as in other similar processes, the risk of damaging the original work is high owing to the operations that directly involve the work such as the application of the thermosetting material on its surface and the pressing operations that involve the same.

### SUMMARY OF THE INVENTION

It is then a feature of the present invention to provide a process to provide reproductions of an object having a decorative three-dimensional surface that allows to obtain reproductions in series highly faithful to the original work.

It is also a feature of the present invention to provide a process to obtain a reproduction of an object that is capable of assuring the safety of the original pictorial work same.

It is also a feature of the present invention to provide a process to obtain a reproduction of an object that is completely automatic and it does not need the intervention of a operator.

These and other features are accomplished by the process, according to the present invention, for producing a duplicate of an object having a decorative three-dimensional surface comprising a plurality of crests, or protrusions, each crest of said plurality having a predetermined thickness (s), or height, said method comprising the steps of:
introducing the object in a container body;
distributing a first hardening material on the object, said first hardening material being arranged to cover the whole decorative three-dimensional surface;
hardening of the hardening material obtaining a mould, said mould being provided, at the face oriented towards the object, of a derived three-dimensional surface that reproduces in negative the three-dimensional surface decorative of the object;
distributing a measured amount of a second hardening material on the derived three-dimensional surface of the mould obtaining a layer of said hardening material of predetermined height;
hardening of the layer of the second hardening material obtaining a cast of the object, said cast having a decorative surface that reproduces the three-dimensional surface of the object, said decorative surface of said cast comprising a plurality of crests with thicknesses corresponding to the thicknesses of said crests of said original work;
printing the decorative surface obtaining a duplicate of the object.

Preferably, said printing step is carried out by means of a printing apparatus.

In particular, the container body has a side containing edge that protrudes, in use, beyond the object same, in order to contain the hardening material that is distributed on the object.

Advantageously, at least one among the first and the second hardening material is a pourable hardening material.

In an exemplary embodiment, the distributing step of the first and/or the second hardening material can be carried out by means of at least one supply nozzle. In particular, the distribution of the first and/or the second hardening material can consist in spraying the first and/or the second hardening material respectively on the object and on the derived three-dimensional surface of the mould. In this way it is possible to obtain a more precise and punctual distribution of the hardening material. Furthermore, this solution assists the automation of the whole process.

Advantageously, said thickness (s) is set between 50 μm and 50 mm.

In particular, the object can be a model reproducing an original work. In particular, the original work has a three-dimensional surface comprising a plurality of crests, or protrusions, each crest of said plurality having a predetermined thickness, or height. In this case, a step is therefore provided of obtaining the object, i.e. the model.

For example, the step of obtaining the model can comprise the following steps:
three-dimensional scanning of the original work obtaining a three-dimensional virtual image corresponding to the three-dimensional surface of the original work, said three-dimensional virtual image comprising a plurality of points, or pixel, having determined spatial coordinates (x,y,z);
producing, on the basis of said spatial coordinates (x,y,z), an object, i.e. the model, having said surface that reproduces said three-dimensional virtual image, said object, or model, being made of a easily workable material.

Advantageously, the step of obtaining the model can be made by means of a 3D printer. In an exemplary embodiment of the invention, the model can be obtained by means of a pantograph.

In particular, the object may be substantially slab-shaped.

It is appropriate to make clear that with the expression “original work” it is generically intended a starting pictorial, or photographic, work having a surface in relief.

In particular, the solution provided by the present invention, unlike the known solutions of prior art, allows to obtain duplicates in series that are highly faithful to the original object.

This result is obtained, in particular, thanks to the fact that the original work is used directly as a model, or to the particular process for obtaining the model, for example by means of a pantograph, or a 3D printer, which allows to obtain a “positive” of the original work.

In particular, the producing step of the model and, then of the crests having a certain thickness s simplifies the successive step of obtaining the “negative”, i.e. the mould. In fact, if you directly pass from the acquisition of the three-dimensional scanning to the mould by means of a suitable working tool that digs the material of a depth simply obtained inverting the sign of the coordinate “z” of the detected points, from +z to −z, you should provide some depressions where the original pictorial work has crests. This would therefore increase the possibility to produce surfaces that are not precise. In other words, a mould would be obtained having a surface reproducing in negative the surface of the work to be duplicated, but with a level of precision lower than that is possible to reach by the present process thanks to the intermediate step of obtaining the model.

With the term “printing” it is generically intended a step of application of a colour on the decorative surface. This can be obtained using different techniques.

In particular, the printing step can be carried out by means of at least one of the following techniques:
printing, or thermo-printing, with sublimation inks;
inkjet printing;
printing with heat transfer printing inks;
printing with water-based inks;
printing with UV inks;
offset printing;
printing with solvent-based inks;
printing with resin-based inks;
laser printing;
serigraphy;
or a combination thereof.

Preferably, the printing apparatus can be a printer, or a plotter, that uses for printing one of the above described technologies.

In particular, as well known, the heat transfer printing provides the transfer of the ink on the surface of the support that has to be printed by the heat generated by a printing heating head. The offset printing, instead, is a process for planographic printing, and it is a printing system that uses planar matrix typical of the phototype and of the lithography.

The method, according to the invention, can provide that the detected data concerning the three-dimensional shape of the surface of the original work by means of the three-dimensional scanning can be recorded on a magnetic, or digital, support or sent to a remote position via an Internet connection. This way, it is possible to delegate the owner and/or directly the author of the work same, to carry out the three-dimensional scanning therefore without falling in the danger that the work can be stolen, or damaged, during the transport. The data obtained by the three-dimensional scanning can then be transmitted to the person who will carry out the following steps provided by the present method for producing the duplicate of the original work.

In particular, before the printing step a patination step of the decorative surface can be provided. More in detail, the patination step, carried out using known technologies, is a process to which the decorative surface is subjected for optimizing the amount of colour, or ink, to be absorbed. For example, the patination step can provide the application of an uniform layer, or film, on the decorative surface for improving the superficial aspect and the printability and therefore improving the quality of the printing.

For example, the patination step can provide the application of a film, in particular a film of resin, on said decorative surface for increasing the absorbing capacity of the inks in order to optimize the quality of the printing.

Alternatively, the printing step can be carried out by means of a laser printer, or plotter.

In addition, to the above described operations, after the printing step, a finishing step of the printed decorative surface can be provided in order to make the surface of each duplicate similar to that one of the original work. More in detail, the finishing step can provide the application of a film, or layer, of a resin, or of an oil, on the printed decorative surface in such a way to obtain the same aesthetic effect of the original work, concerning the brilliance, the opacity, etc.

In particular, after the distributing step of the hardening material in the mould a step is provided of arranging a sheet of base on the layer of the second hardening material, opposite to the mould, said decorative surface being produced opposite to said mould.

In this case, before the printing step a step is provided of arranging said sheet, or support, of base with respect to said printing apparatus, in order to cause the thicknesses made on said layer to coincide with those of the image to be printed, i.e. the image present on said surface of said original work, on said decorative surface.

Advantageously, the model is obtained moulding a semi-finished product of a easily workable material selected from the group comprised of:
a gypsum-based material, in particular a paste, or an aqueous solution, containing gypsum;
a resin, in particular a thermoplastic resin, or a mixture of thermoplastic resins;
or a combination thereof.

Advantageously, the hardening material is a hardening material having a shrinkage coefficient during the step of hardening substantially equal to zero.

In particular, the first hardening material can be selected from the group comprised of:
gypsum;
silicone;
an epoxy resin;
a polyurethane resin;
a thermoplastic resin;
a mixture of thermoplastic resins;
a silicone rubber;
or a combination thereof.

In a preferred exemplary embodiment the first hardening material is silicone.

In particular, the sheet of base can be made of a material selected from the group comprised of:
wood;
cloth;
non woven fabric;
metal material;
plastic material;
a stiff material;
paper, or cardboard.

Advantageously, the sheet of base is made of a flexible material and the second material is selected from the group comprised of:
gypsum, in particular a gypsum-based material;
a mixture of gypsum and of at least one vinyl resin;
a mixture of gypsum and of at least one acrylic resin;
a polyurethane resin;
a thermoplastic resin;
a mixture of thermoplastic resins;
or a combination thereof.

### BRIEF DESCRIPTION OF THE DRAWINGS

The invention will be now shown with the following description of an exemplary embodiment thereof, exemplifying but not limitative, with reference to the attached drawings wherein:

FIG. 1 diagrammatically shows a top plan view of an example of an object to be duplicated using the method, according to the present invention, in order to obtain duplicates highly faithful to the original work;

FIG. 2 shows the original work of FIG. 1 in a cross section according to arrows II-II;

FIG. 3 diagrammatically shows an enlarged view of a portion of the cross section of FIG. 3 for highlighting some morphologic features of the surface of the original work;

FIGS. 4 to 15 diagrammatically show in a cross sectional view a possible succession of steps provided by the method according to the invention to obtain duplicates in series of an object, in particular FIGS. 8A and 8B show two alternative provided for carrying out the distributing step of the hardening material;

FIGS. 16 and 17 diagrammatically show a succession of steps through which it is possible to obtain a model of an original work that can be used as an object from reproducing in series, for example using a 3D scanner usable to provide the scanning step of the original work.

### DETAILED DESCRIPTION OF SOME EXEMPLARY EMBODIMENTS

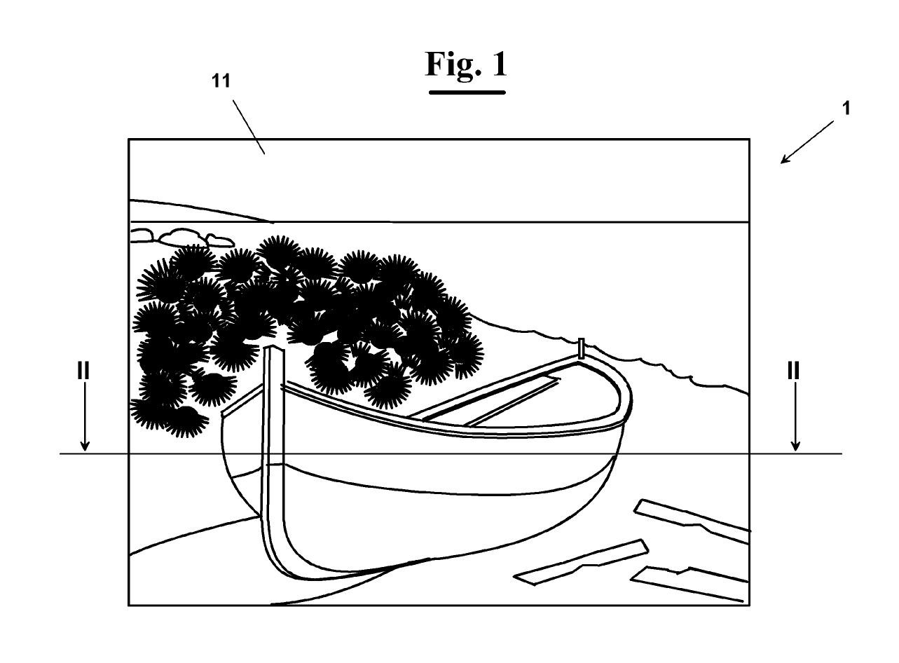

In FIG. 1, it is shown a top plan view of an example of an object 1, such as an pictorial work, or a photography that has a decorative three-dimensional surface 11 and that is possible to reproduce in series through the process, according to the present invention.

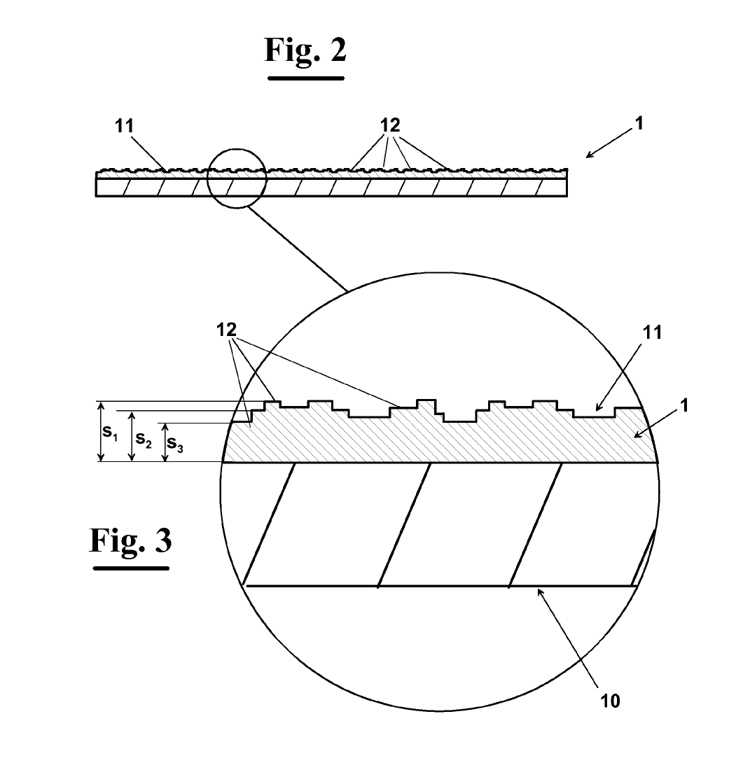

As shown in detail in the cross sectional view of FIG. 2 and, in particular in the enlarged view of FIG. 3, the decorative three-dimensional surface 11 of the object 1 is normally irregular and has a plurality of crests and of depressions 12, for example produced in the case of a pictorial work, or of a photography with parts in relief, by the type of brush-stroke that has been used, and/or by the number of coats, and/or by the amount of colour used by the author, or by the printing machine used, or through a particular working to provide parts in relief of the decorative surface 11. Each crest 12 has, in particular, a specific thickness s, i.e. a predetermined distance from a base surface 10. For example, the thickness, or the height of the crests 12 can be set between 50 μm and 50 mm, advantageously between 0.05 mm and 40 mm, preferably between 0.1 mm and 30 mm.

Therefore, the decorative three-dimensional surface 11 consists of a plurality of crests 12 of different thicknesses, or height.

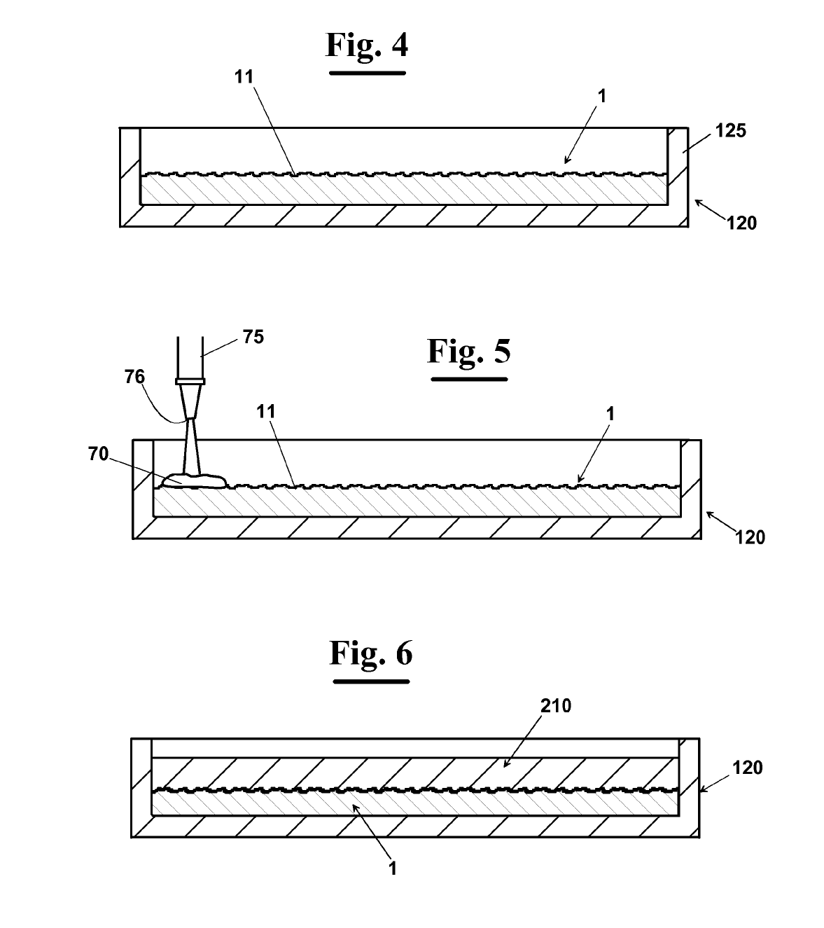

The method provides to put the object 1 to be reproduced in a container body 120 having a side containing edge 125 that, in use, extends in height beyond the object 1 (FIG. 4). Then a step is provided of distributing on the object 1 a first hardening material 70 suitable to cover the whole three-dimensional surface 11 of the object 1. As diagrammatically shown in FIG. 5, the hardening material 70 can be for example distributed on the surface 11 of the object 1 by means of a supplying 75 provided with a nozzle 76.

Once the predetermined hardening level of the hardening material 70 is achieved, a mould 210 is obtained. The hardening material 70 is preferably a material having a shrinkage coefficient substantially equal to zero during the hardening step, such as silicone, gypsum, in particular a material gypsum-based, an epoxy resin, a polyurethane resin, a silicone rubber, or a mixture of two, or more of these substances.

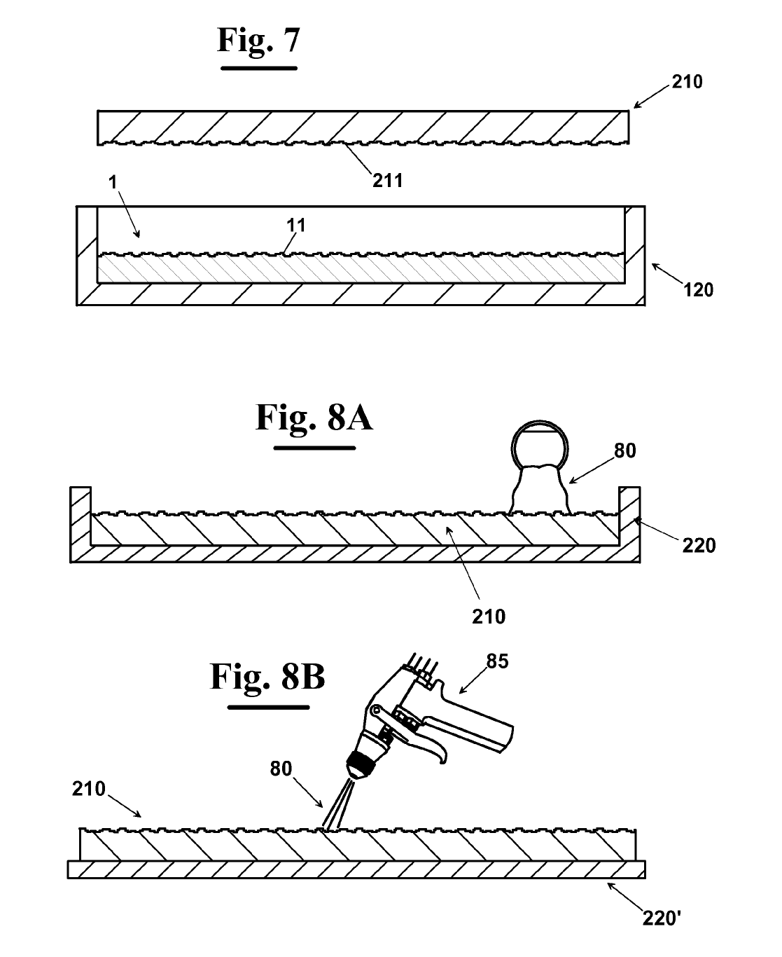

Once hardened, the mould 210, at the face oriented towards the object 1, has a surface 211 reproducing in negative the three-dimensional surface 11 of the object 1 (FIGS. 6 and 7).

The mould 210 is, then, housed in a second container body 220 equipped with, or without, side walls. A step follows of distributing, or pouring, of a second hardening material on the surface 211 of the mould 210 that reproduces in negative the three-dimensional surface 11, obtaining a layer of the same material.

If the distribution is carried out through a spraying of the hardening material 80 (FIG. 8B), for example carried out by a supply gun 85, and then not by pouring from a container as shown in FIG. 8A, it can be enough to arrange the mould 210 on a plane support 220′ because a reduced amount of hardening material distributed in a precise and punctual way can be sufficient.

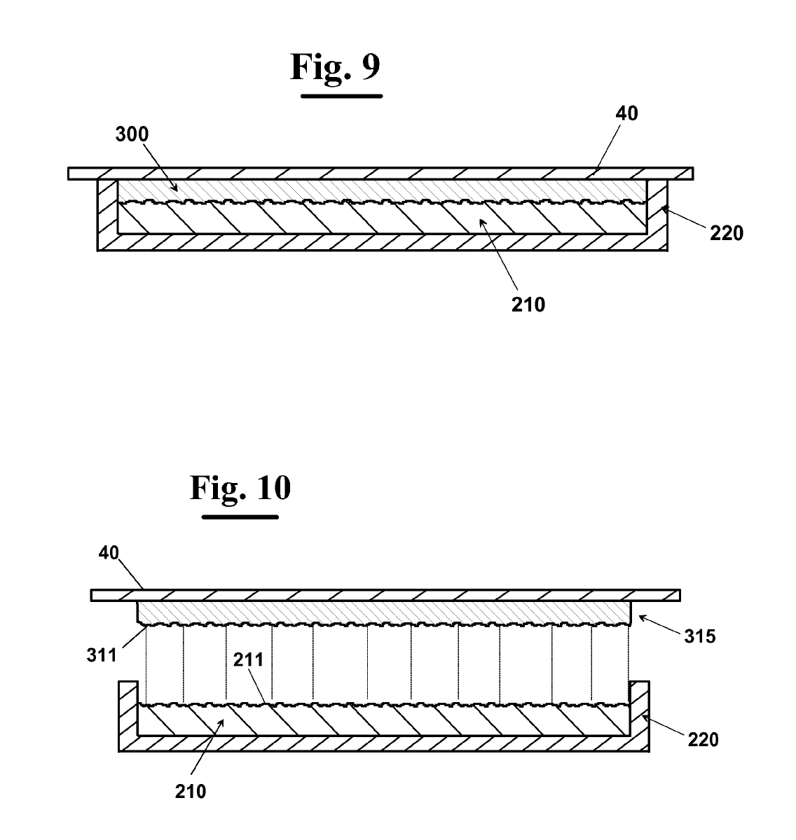

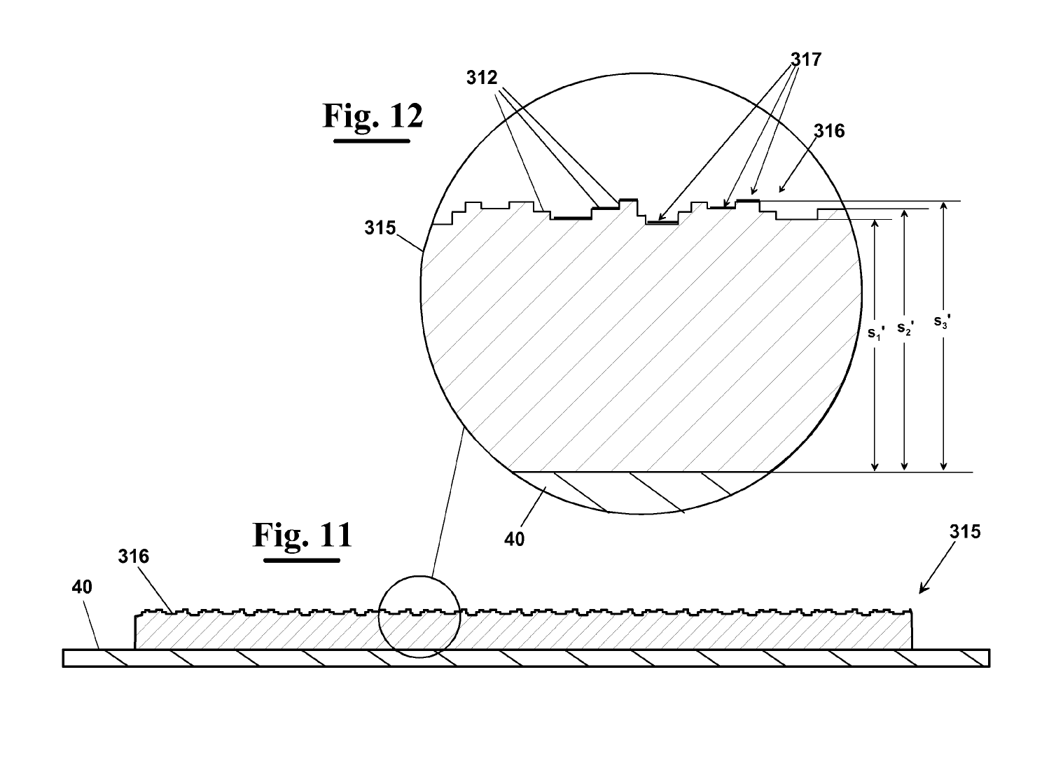

On the layer of the second hardening material, for example a pourable hardening material 80, opposite to the mould 210, a sheet, or support, of base, is arranged for example a sheet of base 40 (FIG. 9). The sheet of base 40 can be slightly pressed on the layer 300 of the second hardening material. Once achieved the predetermined hardening level of the layer 300 it is possible to pass to the successive steps described below.

The sheet, or support, of base 40 can be provided in a stiff material, such as wood, metal, or plastic material. In this case the second hardening material is preferably gypsum, in particular a paste, or aqueous solution, containing the gypsum, in particular a gypsum-based material.

Alternatively, the sheet of base 40 can be made of a flexible material, for example cloth, paper, non woven fabric, or the like. In this case, the second hardening material is preferably a mixture of gypsum and at least one acrylic, or vinyl, resin. In an exemplary embodiment, instead, the second hardening material is a polyurethane resin.

Once the predetermined hardening level of the layer 300 is achieved, a cast 315 is obtained having a decorative surface 316 reproducing in a highly faithful way the three-dimensional surface 11 of the object 1. More in detail, as shown in detail in FIG. 12, the decorative surface 316 of the cast 315 has a plurality of crests 312 corresponding to the thicknesses s of the crests 12 of the three-dimensional surface 11 of the object 1. In particular, the crests 312 may have the same thicknesses s′ of the thicknesses s of the crests 12 of the surface 11 of the object 1, or being in a predetermined ratio with respect to each other for example 1 to 2, 1 to 3, etc.

The decorative surface 316 can be, then, directly subjected to a printing step, in order to obtain, then, a printed decorative surface 317 provided with ink, or colour, in determined points of the surface 316.

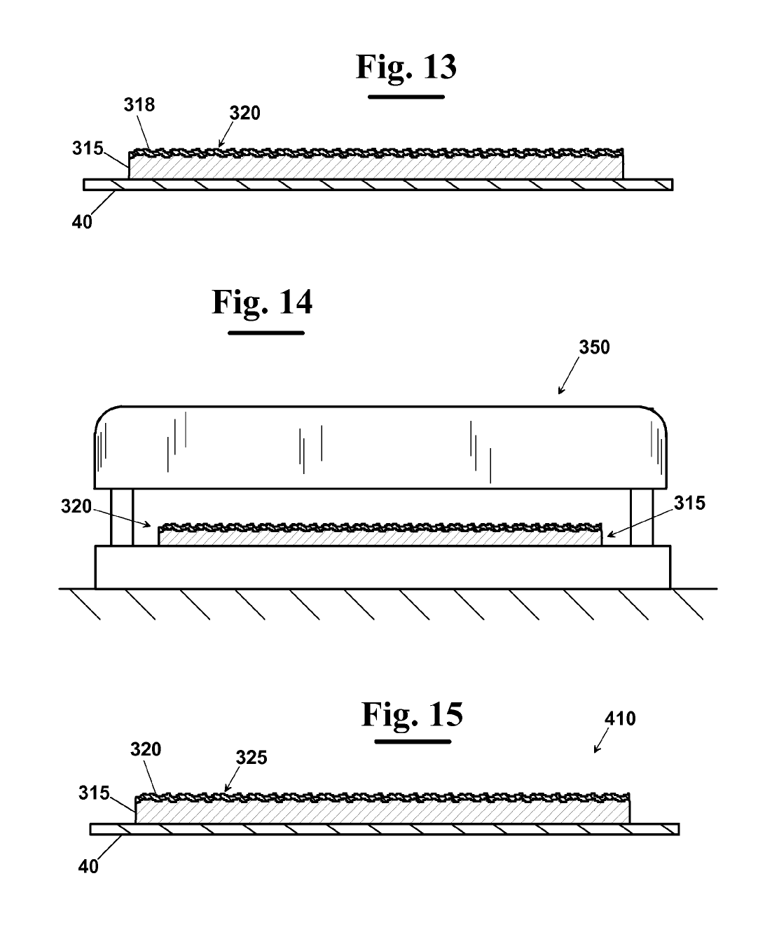

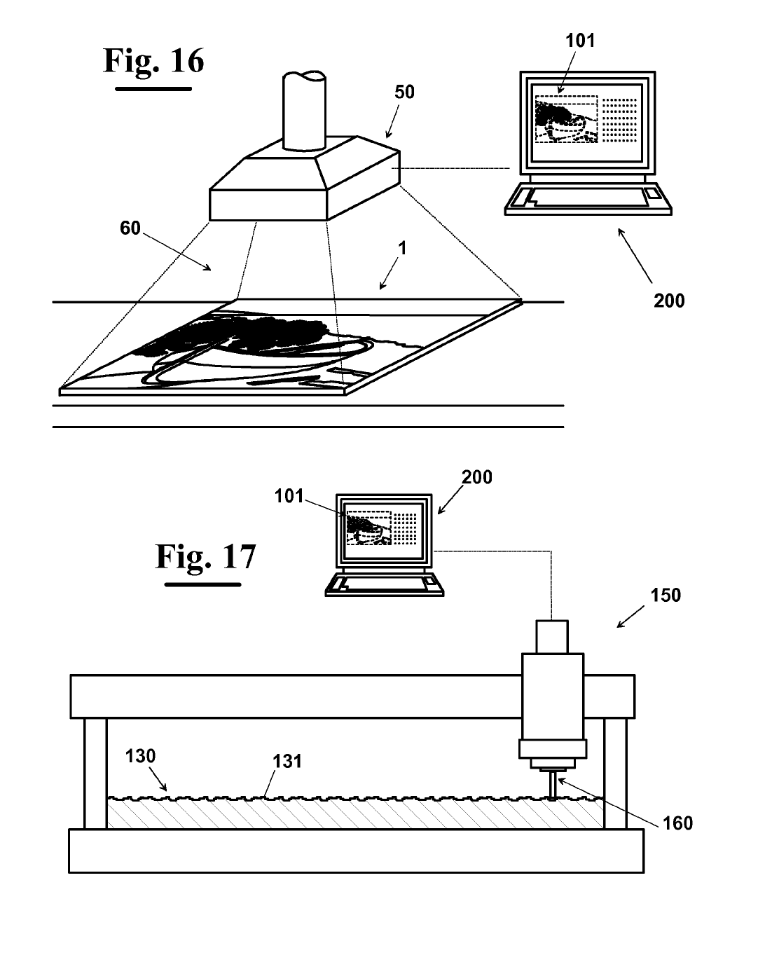

Alternatively, as diagrammatically shown in FIGS. 13 to 15, the surface 316 may be undergone to a patination step obtaining a painted decorative surface 318. The patination step can consist, for example, in the application on the decorative surface 316 of a film 320 of a resin in order to optimize the absorption properties of the colour, in particular of the ink, and allows, therefore, to optimize the quality of the image. The printing step is made by means of an printing apparatus 350, such as a printer, or a plotter. The printing apparatus 350 can use a printing technology such as printing, or thermo-printing, with sublimation inks, inkjet printing, printing with heat transfer inks, printing with water-based inks, printing with UV inks offset printing, printing with solvent-based inks, printing with resin-based inks, serigraphy, laser printing.

In a possible exemplary embodiment of the present invention, the object 1 can be a reproduction of an original work. In this case, a preliminary step of obtaining the object is provided.

For example, the preliminary step of obtaining the model can provide a step of three-dimensional scanning of the original work 1 obtaining a three-dimensional virtual image 101 corresponding to the original work 1. More in detail, the three-dimensional virtual image 101 comprising a plurality of points, or pixels that having determined spatial coordinates (x, y, z).

The above described three-dimensional scanning step can be carried out by means of any 3D scanner 50 of known type. These carry out substantially an optical detection of the surface to be reproduced and measure through a series of data processing the electromagnetic waves reflected by the surface. The 3D scanner usually provides a source of light, for example a source of laser light, or a source of structured light.

In the case of a 3D laser scanner a three-dimensional image is obtained by means of a triangulation that provides the projection of a point, or of a line, of laser light 60 on the surface 11 and a sensor is provided, for example a sensor of CCD type, or a sensor of CMOS type, arranged in a certain position to detect the distance from the surface 11. Once all the surface 11 has been swept, the data obtained are recorded and used for constructing a matrix of points.

In the case of a scanner of structured light, a matrix, or pattern, of light 60 is projected on the surface 11 of the original work 1, and then the deformation is detected to which the projection of the matrix is subjected according to the scanned three-dimensional shape of the surface 11. In this case it is possible to detect the whole field of vision in a single step.

In particular, the virtual image 101 obtained by the scanning step comprises a plurality of points having determined spatial coordinates (x,y,z) that define the three-dimensional geometry of the surface 11 of the original work 1.

The three-dimensional scanning step provided by the present invention allows to measure the spatial coordinates (x,y,z) of the points of the surface 11 of the original work 1, where the value of the z coordinate coincides with the thickness of the crest, or protrusion, 12 of the detected point P.

The assembly of the detected points P and of their coordinates (x, y, z) allows to determine the three-dimensional geometry of the surface 11. This way, it is possible to provide a model 110 made of gypsum, in particular a gypsum-based material, or other easily workable material. This step can be carried out, by a tool 160 of a machine tool 150, for example a pantograph, starting from a semi-finished product 130 having a worked surface 131 (FIG. 17).

The surface of the model 110 will comprise a plurality of points P′ each of which has the spatial coordinates (x, y, z) of the three-dimensional virtual image 101 and therefore corresponding with high precision to the surface 11 of the original work 1. At the end of this work a model 1 is obtained having a surface 11 that is subjected to the steps above described to provide reproductions in series of the original work 110.

The foregoing description of specific exemplary embodiments will so fully reveal the invention according to the conceptual point of view, so that others, by applying current knowledge, will be able to modify and/or adapt in various applications the specific exemplary embodiments without further research and without parting from the invention, and, accordingly, it is meant that such adaptations and modifications will have to be considered as equivalent to the specific embodiments. The means and the materials to realize the different functions described herein could have a different nature without, for this reason, departing from the field of the invention. It is to be understood that the phraseology or terminology that is employed herein is for the purpose of description and not of limitation.

1. Process for producing duplicates in series of an object (1) having a decorative three-dimensional surface (11) comprising a plurality of crests (12), or protrusions, each crest (12) of said plurality having a predetermined thickness, or height (s), said process comprising the steps of:
introducing said object (1) in a container body (120);
distributing a first hardening material (70) on said object (1), said first hardening material (70) being arranged to cover said decorative three-dimensional surface (11) of said object (1);
hardening said hardening material obtaining a mould (210), said mould (210) being provided at the face oriented towards said object (1) of a three-dimensional surface (211) reproducing in negative said three-dimensional surface (11) of said object (1);
distributing a measured amount of a second hardening material (80) on said surface (211) of said mould (210) obtaining a layer (300) of said hardening material (80) having a predetermined height;
hardening said layer (300) of said second hardening material (80) obtaining a cast (315) of said object (1), said cast (315) having a decorative surface (316) reproducing said surface (11) of said object (1), said decorative surface (316) of said cast (315) comprising a plurality of crests (312) with thicknesses corresponding to those one of said crests (12) of said object (1);
printing said decorative surface (316) obtaining a printed decorative surface (317) and then a duplicate of said object (1).

2. Process for producing duplicates of an object (1), according to claim 1, wherein said container body (120) has a side containing edge (125) that, in use, protrudes beyond said object (1).

3. Process, according to claim 1 wherein said object (1) is a model reproducing an original work, said original work having a three-dimensional surface comprising a plurality of crests, or protrusions, each crest of said plurality having a predetermined thickness, or height and being provided, furthermore, a step of obtaining said object comprising the steps of:
three-dimensional scanning of said original work obtaining a three-dimensional virtual image (101) corresponding to said three-dimensional surface of said original work, said three-dimensional virtual image (101) comprising a plurality of points, or pixels having determined spatial coordinates (x,y,z);
producing, on the basis of said spatial coordinates (x,y,z), said model having a surface that reproduces said three-dimensional virtual image (101), said model being made of a easily workable material.

4. Process for producing duplicates of an object, according to claim 1, wherein said printing step is made by means of a printing apparatus (350).

5. Process for producing duplicates of an object (1), according to claim 4, wherein said printing apparatus (350) uses one of the following printing technologies:
printing, or thermo-printing, with sublimation inks;
inkjet printing;
printing with heat transfer printing inks;
printing with water-based inks;
printing with UV inks;
offset printing;
printing with solvent-based inks;
printing with resin-based inks;
laser printing;
serigraphy;
or a combination thereof.

6. Process to provide duplicated of an object (1), according to claim 1, wherein before said printing step a patination step of said decorative surface is provided, said patination step being adapted to optimize the colour absorption level, in particular ink from said decorative surface (316).

7. Process for producing duplicates of an object (1), according to claim 6, wherein said patination step provides a step of application of a film (318) of resin on said decorative surface (316) for optimizing the absorption properties of the colour, in particular of ink, and then optimizing, the printing quality.

8. Process for producing duplicates of an object (1), according to claim 1, wherein after said printing step, a finishing step of said printed decorative surface (317) is provided, said finishing step being arranged to obtain on said printed decorative surface (316) a same aesthetic effect of said object (1), concerning the brilliance, the opacity.

9. Process for producing duplicates of an object (1), according to claim 1, wherein after said distributing step of said first hardening material (70) in said mould (210) the steps are provided of: arranging a sheet (40), or support, of base on said layer (300) of said second hardening material, opposite to said mould (210), said decorative surface (316) being carried out opposite to said sheet (40), or support, of base; arranging said sheet (40), or support, of base with respect to said printing apparatus (350), in such a way to cause the thicknesses of said layer (300) of said second hardening material (80) to coincide those one of an image to be printed on said decorative surface (316).

10. Process for producing duplicates of an object (1), according to claim 4, wherein said model is made moulding a semi-finished product of a easily workable material selected from the group comprised of:
gypsum, in particular a gypsum-based;
a resin;
or a combination thereof.

11. Process for producing duplicates of an object (1), according to claim 1, wherein said first hardening material (70) is a hardening material having a shrinkage coefficient during the hardening step substantially equal to zero, said first hardening material (70) being selected from the group comprised of:
gypsum, in particular a gypsum-based material;
silicone;
an epoxy resin;
a polyurethane resin;
a silicone rubber;
or a combination thereof.

12. Process for producing duplicates of an object (1), according to claim 9, wherein said sheet (40), or support, of base is made of a material selected from the group comprised of:
wood;
cloth;
non woven fabric;
metal material;
plastic material;
a stiff material;
paper, or cardboard.

13. Process for producing duplicates of an object (1), according to claim 9, wherein said sheet of base (40) is made of a stiff material and said second hardening material (80) is selected from the group comprised of:
a gypsum-based material;
a resin;
or a combination thereof.

14. Process for producing duplicates of an object (1), according to claim 13, wherein said gypsum-based material is selected from the group comprised of:
a paste containing gypsum;
an aqueous solution containing gypsum.

15. Process for producing duplicates of an object (1), according to claim 13, wherein said resin is selected from the group comprised of:
a thermoplastic resin;
a mixture of thermoplastic resins.

16. Process for producing duplicates of an object (1), according to claim 13, wherein said stiff material is selected from the group comprised of: wood, metal, or plastic material.

17. Process for producing duplicates of an object (1), according to claim 9, wherein said sheet of base (40) is made of a flexible material and said second hardening material (80) is selected from the group comprised of:
a mixture of gypsum and of at least one vinyl resin;
a mixture of gypsum and of at least one acrylic resin;
a polyurethane resin;
a thermoplastic resin;
a mixture of thermoplastic resins;
or a combination thereof.

18. Process for producing duplicates of an object (1), according to claim 17, wherein said flexible material is selected from the group comprised of:
cloth;
paper;
non woven fabric.

19. Process for producing duplicates of an object (1), according to claim 1, wherein said thickness, or height, is set between 50 μm and 50 mm.

20. Process for producing duplicates of an object (1), according to claim 1, wherein at least one among said first and said second hardening material (70, 80) is a pourable hardening material.

21. Process for producing duplicates of an object, according to claim 1, wherein said distributing step of said first and/or of said second hardening material consists of a spraying of said first and/or of said second hardening material respectively on said object and on said derived three-dimensional surface of said mould.

22. Process for producing duplicates of an object, according to claim 3, wherein said obtaining step of said model is carried out by means of a 3D printer.

23. Process for producing duplicates of an object, according to claim 3, wherein said obtaining step of said model is carried out by means of a pantograph.
